(19) United States
(12) Patent Application Publication
(10) Pub. No.: US 2012/0295107 A1
(43) Pub. Date: Nov. 22, 2012

(54) FABRICATION METHOD OF GRAPHENE-CONTROLLED NANO-GRAPHITE

(75) Inventor: Jae Kap LEE, Seoul (KR)

(73) Assignee: KOREA INSTITUTE OF SCIENCE AND TECHNOLOGY, Seoul (KR)

(21) Appl. No.: 13/475,110

(22) Filed: May 18, 2012

(30) Foreign Application Priority Data
May 18, 2011 (KR) 10-2011-0046946

(51) Int. Cl. C01B 31/04; B32B 9/00; B82Y 40/00; B82Y 30/00

(52) U.S. Cl. 428/367; 423/448; 977/842; 977/734

(57) ABSTRACT

The present invention relates to a method of fabricating a carbon material and, more particularly, to a method for fabricating graphite having a nano-ribbon shape (hereinafter, referred to as a ‘graphene-controlled nano-graphite’) through a heat treatment of graphene nano-powders, and a graphene-controlled nano-graphite fabricated through the method. The method for fabricating graphene-controlled nano-graphite includes a preparation step of preparing graphene powders and a fabrication step of fabricating graphene-controlled nano-graphite through heat treatment of the graphene powders. The graphene powder may be fabricated by disintegrating crystalline graphite.

### CROSS-REFERENCE TO RELATED APPLICATION

Pursuant to 35 U.S.C. §119(a), this application claims the benefit of earlier filing date and right of priority to Korean Application No. 10-2011-0046946, filed on May 18, 2011, the contents of which is incorporated by reference herein in its entirety.

### FIELD OF THE INVENTION

The present invention relates to a method of fabricating a carbon material and, more particularly, to a method for fabricating thin (nano-) graphite (thinner than 10 nm) having a nano-ribbon shape (hereinafter, referred to as a ‘grpahene-controlled nano-graphite’) by a heat treatment of graphene (nano-)powders, and graphene-controlled nano-graphite fabricated through the method.

### DESCRIPTION OF THE RELATED ART

Graphene, a basic unit of a graphitic material, is a layer of carbon atoms which are combined two-dimensionally forming hexagons, and has a thickness of about 0.4 nm. Such graphene may exist as a single layer, or randomly oriented numerous layers. The former is called a ‘graphene sheet’, and the latter is called a ‘graphene powder’, and both of them may be simply called graphene. Namely, graphene powder is an aggregate of disorderly gathered graphene sheets. There are many reports for physical properties of graphene sheets to be better than those of any other materials including carbon nonotubes.

In order to utilize the excellent properties of graphene, graphene sheets should be large, larger than tens of nm. However, it is very difficult to fabricate such a large (pure) graphene sheet due to the van der waals force working between graphene sheets. Furthermore, graphene is energetically unstable, and tends to form graphite.

Thus, thin graphite having a thickness of thinner than 10 nm (approximately corresponding to the thickness of 25 graphene layers) has emerged as an alternative of graphene. Chemical treatment of crystalline graphite, which is a kind of a top-down approach, has been suggested to fabricate thin graphite sheets (5˜100 nm in thickness). However, the chemical methods can hardly control the thickness of graphite and is not environmental-friendly.

A graphitic material stacked with two or more sheets of graphene is ‘graphite’. Conventional graphite is fabricated by a heat treatment of pitch, or the like, at a high temperature ranging from 2,000 to 3,000° C., and shows irregular shapes in micron size. Meanwhile, chemical vapor deposition (CVD) method, which fabricates graphite at a relatively mild condition, 1,000˜1,500° C. provides a way of fabricating nano-graphite (or nano carbon). An example is the synthesis of nanoribbon-typed graphite [K. S. Kim et al., IEEE Transactions on Plasma Science, Vol. 35, No. 2, 434 (2007)]. The graphite nanoribbons synthesized by CVD method are thick, as the thickness thereof is usually 10 nm or thicker. Such thick graphite is not ideal for the elements for high performance composites (transparent and flexible electrodes). Also, CVD method has the radical problem that a mass production of (thin or nano) graphite is impossible.

### SUMMARY OF THE INVENTION

An aspect of the present invention provides a method for fabricating graphene-controlled nano-graphite using graphene nano-powders. The nano-materials are in the form of nano-ribbon of which average thickness is ≦10 nm (corresponding to the thickness of 25 graphene layers) and width is ≦10 nm. The method is environmental-friendly. The present invention provides a mass production route to thin graphite. The graphite nanoribbons of the present invention have excellent flexibility corresponding to that of single-wall carbon nanotubes, due to their narrow and thin feature.

In the present invention, ‘length’ is used mixed with ‘size’, unless otherwise mentioned.

The present invention is a bottom-up approach to nano-graphite. The present invention comprises a preparation step and a fabrication step. The preparation step includes a process of synthesizing graphene nano-powders as starting materials, and the fabrication step includes a process heating the graphene nano-powders.

In the preparation step, the graphene nano-powders to be used for starting materials are prepared. The graphene nano-powders may be fabricated by including a process of disintegrating crystalline graphite using a mechanical or chemical method, or any other method, wherein a purifying process for removing the impurities which can be incorporated during the graphene nano-powder synthesis process.

The graphene nano-powders are aggregations of nano-sized graphene sheets which are disorderly oriented. The samples are mostly composed of pure graphene where a thickness is about 0.4 nm, that is, a single layer of carbon atoms (stochastically, some graphene layers can be stacked in parallel). Also, the size of the graphene nano-powders may be in the range between 3 and 50 nm, and the average size may be between 3 and 10 nm. Averages of the widths and lengths thereof may range from 3 to 5 nm and 5 to 10 nm, respectively.

The graphene nano-powders can be confirmed by HRTEM and XRD analysis. In HRTEM analysis, the graphene nano-powders appear to be randomly oriented layers although there may be some parts in which graphene layers appear to be stacked in parallel, and the latter can be seen as graphite with a thickness of a few nm, (FIG. 1A). In XRD analysis, the appearance of the broad (002) peak of which FWHM (full width at half maximum) is 5° or greater, preferably, 7° or greater, can be the direct evidence for graphene nano-powders.

Next, the fabrication step may include loading the graphene material in a vacuum chamber, vacuuming the vacuum chamber, introducing an inert gas into the vacuum chamber, maintaining the vacuum chamber in a certain pressure, and heating the graphene powders to fabricate graphene-controlled nano-graphite at a temperature higher than 1,400° C. and lower than 3,000° C. Preferably, the heat treatment may be performed at a temperature ranging from 1,400° C. to 2,000° C., and most preferably, the heat treatment may be performed at a temperature ranging from 1,400° C. to 1,500° C. Also, the heat treatment may be performed in a vacuum state without introducing an inert gas. Fabrication of graphene-controlled nano-graphite is completed by the two steps (i.e., the bottom-up approach).

FIGS. 1 and 2 show HRTEM images and XRD patterns before and after the heat treatment. The conversion of the graphene powders to (FIG. 1A) the graphene layered material, i.e., nano-graphite (FIG. 1B) by the heat treatment is evident. The graphene-controlled nano-graphite may have a nano-ribbon shape having a thickness of 20 nm or thinner, an average thickness of 10 nm or thinner, and a length greater than the thickness and the width thereof. Also, the graphene-controlled nano-graphite may have a thickness ranging from 1 to 20 nm and an average thickness ranging from 2 to 10 nm.

The XRD pattern showing clear peaks at 2θ=26° ((002) peak), 43°, 53°, and 78° (FIG. 2) confirms that the graphitic material is graphite (i.e., crystalline). It can be noted that the graphene-controlled nano-graphite has the AA′ stacking because the (002) peak appears at 2θ=26°.

According to the present invention, nano-ribbon graphite with an average thickness 10 nm or thinner, corresponding to 25 or less graphene layers, and a fabrication method thereof are provided. This bottom-up approach provides a simple and mass producible route to nano-graphite Thus, the graphene-controlled nano-graphitecan be used as a basic material for Li-ion battery electrode, a flexible electrode, and a high strength-to-weight ratio composite.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows HRTEM images for graphene powder (A) and graphene-controlled nano-graphite (B) fabricated according to the method of the present invention.

FIG. 2 shows XRD patterns of graphene powder (above) and graphene-controlled nano-graphite (below) fabricated according to the method of the present invention.

### DETAILED DESCRIPTION OF THE INVENTION

Embodiments of the present invention will be described in detail such that they can be easily implemented by a person in the art to which the present invention pertains. However, the present invention may be embodied into various forms and not limited to the embodiments described herein.

### EXAMPLE 1

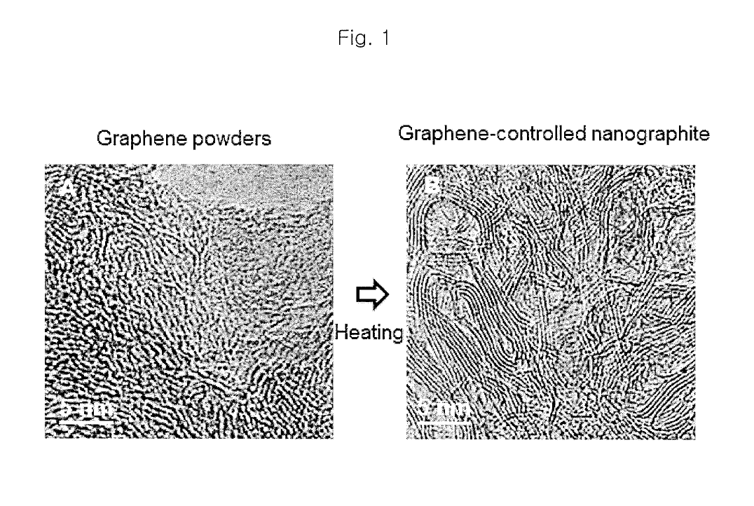

1 g of graphene (nano-)powder is prepared by disintegrating helical graphite with a mechanical method. The graphene powders show a nano-ribbon shape with width and length of 5 nm or smaller and 10 nm or smaller, respectively. The graphene powders are loaded in a vacuum chamber and heated at 1,500° C. is for 30 minutes. In this case, the temperature was measured by a pyrometer, and may have a deviation of ±50° C. The heat treatment was performed in the conditions of pressure of 100 torr under a hydrogen (inert gas) atmosphere and a gas flow rate of 200 sccm. HRTEM images shown in FIGS. 1A and B confirm that the graphene nano-powders converted into crystalline graphite (graphene-controlled nano-graphite)by the heat treatment. The graphene-controlled nano-graphite is expected to have a thickness of a few nm or thinner (approximately, ten or smaller of the graphene layers having a thickness of about 20 nm or thinner) and a length of tens of nm (10 to 100 nm).

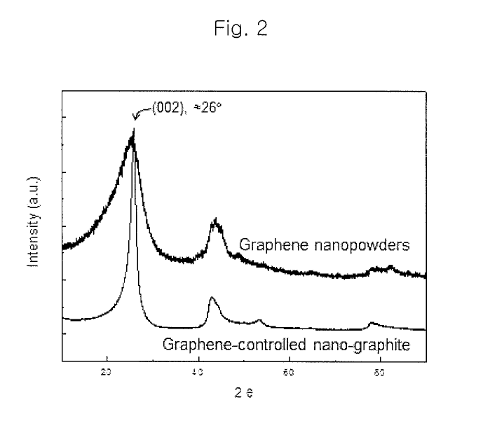

FIG. 2 shows XRD patterns of the samples before and after the heat treatment. With the heat treatment, clearer peaks appear at 26° (the strongest), 43° (second strongest), 53°, and 78° (FIG. 2 below). XRD analysisis consistent with the morphological changes confirmed by HRTEM images shown in FIG. 1, verifying that the graphene nano-powders which exist randomly converted into crystalline graphite, i.e., nano-graphite through the heat treatment. Also, it could be noted that the graphene-controlled nano-graphite has the AA′ stacking structure because the (002) peak of the graphene-controlled nano-graphite appear at 26°.

### EXAMPLES 2-1 TO 2-4

In order to check a lower boundary of the temperature range for the heat treatment at which the graphene nano-powder converts into the graphene-controlled nano-graphite. Temperatures were changed between 1300 and 1500° C. in Examples 2-1 to 2-4, and heat-treated samples were analyzed by HRTEM and XRD. Here, the graghene nano-powders samples and the conditions for the heat treatment were the same with those of Example 1. The results are shown in Table 1.

An average thickness of the graphene-controlled nano-graphite having a ribbon shape fabricated under the conditions of Examples 2-1 to 2-4 was 10 nm or thinner (occasionally, some were observed to have a thickness of 20 nm).

It has been well-known that graphite is stable at a high temperature of 3,000° C. or lower and crystalline thereof is enhanced toward higher temperature. Thus, the upper boundary of the temperature range may be 3,000° C. As shown in Table 1 below, it appeared that morphological change was completed at about 1,500° C. (heat treatment for 30 minutes). The result indicates that 1,500° C. is enough for the the fabrication of graphene-controlled nano-graphite using the graphene nano-powders as starting materials

TABLE 1

| | | | Observation of nano- |
|---|---|---|---|
| | Temperature of | FWHM of | ribbon graphite in |
| | heat treatment (° C.) | XRD (002) | HRTEM analysis |
| Example 2-1 | 1,300 | 5.45 | x |
| Example 2-2 | 1,400 | 3.59 | Δ (partially observed) |
| Example 2-3 | 1,450 | 3.08 | Δ (partially observed) |
| Example 2-4 | 1,500 | 2.14 | ∘ |

* Heat treatment conditions: hydrogen plasma generated at 100 Torr for 30 minutes.

From the results of Examples 1, and 2-1 to 2-4, it is expected that the conversion from the graphene powders to graphene-controlled nano-graphite start sat about 1,400° C. and completes at about 1,500° C. However, the lower side of temperature range for the heat treatment may be changed according to conditions such as a process time, an energy source of synthesizing equipment, a temperature measurement method, defect and size of graphene, a gas pressure, and the like.

As the present invention may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. A method for fabricating graphene-controlled nano-graphite, the method comprising:
a preparation step which prepares graphene powders; and
a fabrication step which fabricates graphene-controlled nano-graphite through a heat treatment of the graphene powders.

2. The method of claim 1, wherein the graphene powders are prepared by disintegrating crystalline graphite.

3. The method of claim 1, wherein the graphene powders are nano-sized graphene sheets which exist randomly.

4. The method of claim 1, wherein the size of the graphene powder is 50 nm or smaller, and an average size thereof is 10 nm or smaller.

5. The method of claim 1, wherein FWHM (full width at half maximum) of the (002) peak in the XRD pattern for the graphene powders is 5° or greater.

6. The method of claim 1, wherein the heat treatment is performed at a temperature of 1400° C. or higher and lower than 3,000° C.

7. The method of claim 1, wherein the heat treatment is performed under a vacuum or inert gas atmosphere.

8. The method of claim 1, wherein graphene-controlled nano-graphite has a thickness of 20 nm or thinner, an average thickness of 10 nm or thinner, and a length longer than the thickness and the width, and has a nano-ribbon shape.

9. A graphene-controlled nano-graphite which is fabricated according to the method of claim 1, wherein the graphene-controlled nano-graphite is in the form of nanoribbons which are flexible due to the thickness of 20 nm or thinner, and an average thickness of 10 nm or thinner.

10. The graphene-controlled nano-graphite of claim 9, wherein, in XRD patterns for the graphene-controlled nano-graphite, peaks appear at 2θ=26°, 43°, 53°, and 78° where the strongest and the second strongest peaks appear at 2θ=26° and 43°, respectively.

11. The graphene-controlled nano-graphite of claim 9, wherein the graphene-controlled nano-graphite has AA′ stacking structure.
